(19) United States
(12) Patent Application Publication
(10) Pub. No.: US 2018/0084732 A1
(43) Pub. Date: Mar. 29, 2018

(54) COMBINATION POWER PLANT AND INTENSIFIED FARM

(71) Applicant: GENERAL ELECTRIC COMPANY, SCHENECTADY, NY (US)

(72) Inventors: Todd Garrett Wetzel, Rexford, NY (US); Stephen Duane Sanborn, Copake, NY (US); Matthew Alan Petersen, Clifton Park, NY (US); Hareesh Kumar Reddy Kommepalli, Albany, NY (US)

(21) Appl. No.: 15/280,403

(22) Filed: Sep. 29, 2016

(51) Int. Cl. A01G 7/02; A01B 79/02

(52) U.S. Cl. CPC A01G 7/02; A01B 79/02

(57) ABSTRACT

A combination power plant and intensified farm includes a power plant and an intensified farm. The power plant generates electricity and an exhaust stream. An exhaust cleanup facility captures CO₂ from the exhaust stream. The intensified farm receives at least a portion of CO₂ from the exhaust cleanup facility to assist in the raising of at least one crop. If necessary, the intensified farm receives at least a portion of electricity from the power plant. In another embodiment, the exhaust cleanup facility also provides H₂O to the intensified farm. In another embodiment, a NOx to fertilizer conversion facility converts NOx from the exhaust cleanup facility to a fertilizer and provides the fertilizer to the intensified farm. In another embodiment, a gasifier or digester receives an inedible biomass from the intensified farm and converts the inedible biomass to a fuel, which is to the power plant.

### BACKGROUND

The invention relates in general to power plants, and more particularly to a combination power plant, such as a fossil fuel power plant, and the like, and an intensified farm, such as a vertical farm, and the like, that ideally consumes 100% of the CO₂ produced by the power plant.

In a world where 870 million people go to bed hungry every night (UN, 2012), 1.4 billion people are overweight (WHO, 2008), arable land, fresh water and fertilizers are resource intensive, it is clear that innovative solutions are needed.¹ www.vertical-farming.net

Four global challenges we need to solve:

1) Fertilizer use leading to:
agricultural runoff
ocean eutrophication;

2) Fresh water use:
80% of all freshwater is used in agriculture;

3) Food transport leads to:
significant food waste;
greenhouse gas emissions; and

4) Rapid urbanization:
expected 10 billion people globally by 2050;
80% urban population by 2050;
increasing demand for food in cities.

By the year 2050, it is estimated that the human population will increase by another 3 billion individuals. Our present agricultural footprint is the size of South America. To feed the coming 3 billion people, we would need an additional landmass the size of Brazil.

In recent years, various forms of intensified farms or vertical farms have appeared on the market around the world. These new farming techniques shed the free resources water, sun, air and soil for an artificially created indoor environment. Examples range from common greenhouses, to “vertical urban farms”. In the latter, crops are brought into buildings, where water, nutrients, and lighting are supplied artificially. There are 10 advantages of vertical farming:

1) Limited Agricultural Runoff;

2) Year round crop production;

3) Resilient to climate change;

4) Uses up to 98% less water compared to open field agriculture;

5) Less food miles due to local production;

6) Creates new green jobs;

7) Promotes restoration of damaged ecosystems;

8) Ideal for vacant urban spaces;

9) Higher yields and faster growth rates; and

10) Delivers consistent, fresh and local produce.

While these techniques are growing at a fast rate, they still contribute an insignificant amount of food to the populations of the world. It is also true that individual installations are currently relatively small.

Therefore, there is a need for an advanced intensified farming technique that will provide a significant amount of food to the populations of the world.

### BRIEF DESCRIPTION

The problem of providing an advanced intensified farming technique that will provide a significant amount of food to the populations of the world is solved by combining a fossil fuel power plant with an intensified farm that consumes 100% of the CO₂ produced by the power plant, uses a portion of the electricity, and potentially captures water and Nitrogen from the exhaust stream of the fossil fuel power plant.

In accordance with one embodiment, a combination power plant and intensified farm comprises a power plant for generating electricity and an exhaust stream, an exhaust cleanup facility for capturing CO₂ from the exhaust stream, and an intensified farm operatively coupled to the fossil fuel power plant and the exhaust cleanup facility, wherein at least a portion of CO₂ from the exhaust cleanup facility is provided to the intensified farm to assist in raising of at least one crop.

In accordance with one embodiment, a combination power plant and intensified farm comprises a power plant for generating electricity and an exhaust stream, an exhaust cleanup facility for capturing CO₂ from the exhaust stream, and an intensified farm operatively coupled to the fossil fuel power plant and the exhaust cleanup facility, wherein at least a portion of electricity from the power plant and at least a portion of CO₂ from the exhaust cleanup facility is provided to the intensified farm to assist in raising of at least one crop.

In accordance with still another embodiment of the present techniques, a combination power plant and intensified farm comprises a power plant for generating electricity and an exhaust stream, an exhaust cleanup facility for capturing CO₂ and H₂O from the exhaust stream, a NOx to fertilizer conversion facility operatively coupled to the exhaust cleanup facility and the intensified farm that converts NOx from the exhaust cleanup facility to a fertilizer, and an intensified farm operatively coupled to the fossil fuel power plant and the exhaust cleanup facility, wherein at least a portion of electricity from the power plant and at least a portion of CO₂ and H₂O from the exhaust cleanup facility is provided to the intensified farm to assist in raising of at least one crop, and wherein at least a portion of the fertilizer from the NOx to fertilizer conversion facility is provided to the intensified farm.

### DRAWINGS

These and other features and aspects of embodiments of the present invention will become better understood when the following detailed description is read with reference to the accompanying drawings in which like characters represent like parts throughout the drawings, wherein:

FIG. 1 is an exemplary representation of a combination power plant, such as a fossil fuel power plant, and an intensified farm in which a portion of the CO₂ generated by the power plant is provided to the intensified farm according to an embodiment of the invention;

FIG. 2 is an exemplary representation of a combination power plant, such as a fossil fuel power plant, and an intensified farm in which a portion of the CO₂ and electricity generated by the power plant is provided to the intensified farm according to an embodiment of the invention;

FIG. 3 is an exemplary representation of a combination power plant, such as a fossil fuel power plant, and an intensified farm in which a portion of the CO₂, H₂O and electricity generated by the power plant is provided to the intensified farm according to an embodiment of the invention;

FIG. 4 is an exemplary representation of a combination power plant, such as a fossil fuel power plant, and an intensified farm in which a portion of the CO₂, H₂O, NOx and electricity generated by the power plant is provided to the intensified farm according to an embodiment of the invention; and

FIG. 5 is an exemplary representation of a combination power plant, such as a fossil fuel power plant, and an intensified farm in which a portion of the CO₂, H₂O, NOx and electricity generated by the power plant is provided to the intensified farm, and inedible biomass from the intensified farm is provided to a gasifier or digester and converted to fuel for the power plant according to an embodiment of the invention.

### DETAILED DESCRIPTION

Unless defined otherwise, technical and scientific terms used herein have the same meaning as is commonly understood by one of ordinary skill in the art to which this disclosure belongs. The terms “a” and “an” do not denote a limitation of quantity, but rather denote the presence of at least one of the referenced items. The term “or” is meant to be inclusive and mean one, some, or all of the listed items. The use of “including,” “comprising” or “having” and variations thereof herein are meant to encompass the items listed thereafter and equivalents thereof as well as additional items.

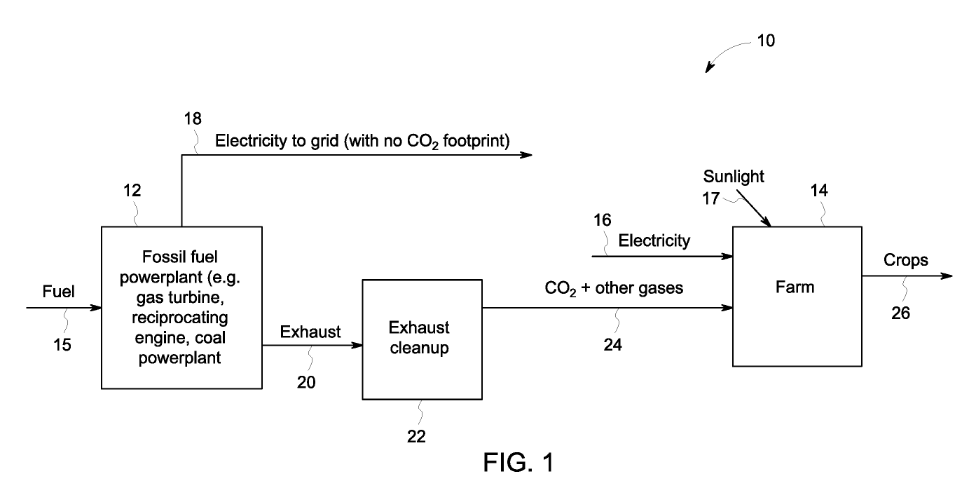

Referring now to FIG. 1, a basic, exemplary representation of a combination power plant and intensified farm, shown generally at 10, in which a portion of the CO₂ generated by the power plant is provided to the intensified farm according to an embodiment of the invention. The combination power plant and intensified farm 10 includes a power plant 12 and an intensified farm 14. The power plant 12 may comprise a cogeneration power plant, a coal power plant, a natural gas power plant, and the like. In one embodiment, the power plant 12 includes a gas turbine, a reciprocating engine, and the like, that uses fossil fuel provided in line 15 to generate CO₂ and electricity. The fossil fuel 15 may comprise coal, natural gas, and the like. In the illustrated embodiment, the intensified farm 14 comprises a vertical farm, and the like.

Vertical farming is the practice of producing food in vertically stacked layers, vertically inclined surfaces and/or integrated in other structures. The modern idea of vertical farming uses controlled-environment agriculture (CEA) technology, where all environmental factors can be controlled. These facilities utilize artificial control of light, environmental control (humidity, temperature, gases . . . ) and fertigation. Some vertical farms use techniques similar to greenhouses, where natural sunlight can be augmented with artificial lighting and metal reflectors. (See, for example, https://en.wikipedia.org/wiki/Vertical_farming).

As shown in FIG. 1, the intensified farm 14 receives electricity from the grid (not shown) in line 16 to provide basic electrical power to the intensified farm 14 and sunlight 17 to assist in the growing of at least one crop 26. In this embodiment, the electricity in line 16 provided to the intensified farm 14 is not used for the growing crops 26, but for providing basic electrical power to the intensified farm 14. The energy needed for the growing of crops 26 is provided by sunlight 17. Thus, all of the electricity generated by the power plant 12 is provided to the grid (not shown) in line 18. In the illustrated embodiment in which the power plant 12 uses fossil fuel 15, the power plant 12 also generates an exhaust stream 20, which contains CO₂ and other gases. The exhaust stream 20 is sent to an exhaust cleanup facility 22 of a type well-known in the art, which captures the CO₂ and other gases from the exhaust stream 20. In turn, the exhaust cleanup facility 22 provides CO₂ and the other gases in line 24 to the intensified farm 14 to assist in growing at least one crop 26. As a result, the electricity provided to the grid in line 18 is provided with no CO₂ footprint.

As described above in a basic design of the combination power plant and intensified farm 10, at least a portion of the CO₂ generated by the power plant 12 is supplied to the farm 14 to assist in growing one or more crops 26. In this design, the farm 14 consumes at least 50% of the CO₂, and ideally 100% of the CO₂ produced by the power plant 12. As output, the combination power plant and intensified farm 10 of the invention delivers electricity 18 to the grid (not shown) with zero carbon footprint, and produces a significant amount of crop(s) 26 for local consumption.

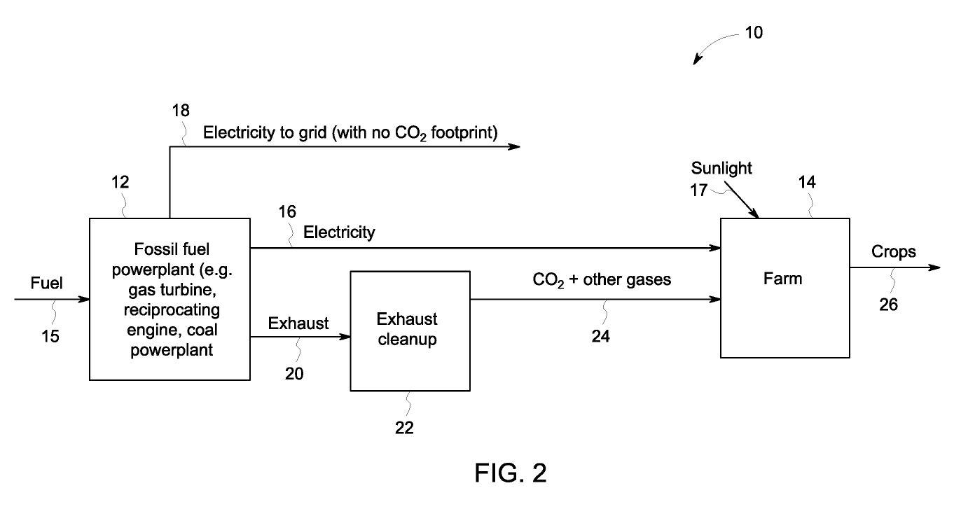

Referring now to FIG. 2, a combination power plant and intensified farm 10 is shown according to an alternate embodiment of the invention. In this embodiment, the combination power plant and intensified farm 10 is identical to the design shown in FIG. 1, with the addition that a portion of the electricity from the power plant 12 is provided to the intensified farm 14 in line 16. The portion of the electricity in line 16 can be used to provide artificial light, such as light emitting diodes (LEDs), and the like, to assist in growing crops 26. As a result, the intensified farm 14 requires a less amount of sunlight 17 to assist in growing one or more crops 26.

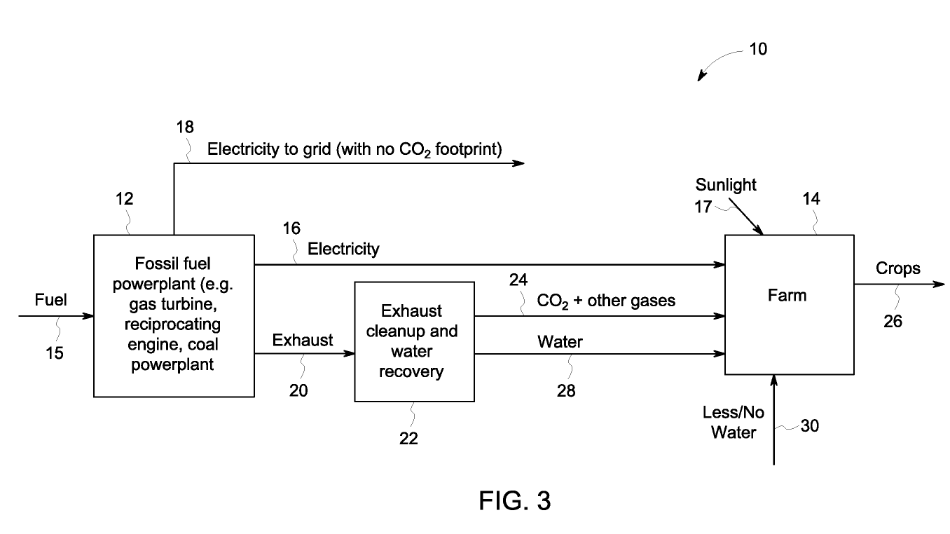

Referring now to FIG. 3, a combination power plant and intensified farm 10 is shown according to an alternate embodiment of the invention. In this embodiment, the combination power plant and intensified farm 10 is identical to the design shown in FIG. 2, with the addition that H₂O from the exhaust cleanup facility 22 is also provided in line 28 to the intensified farm 14. As a result, the intensified farm 14 requires a less amount or no water in line 30 to assist in growing crops 26.

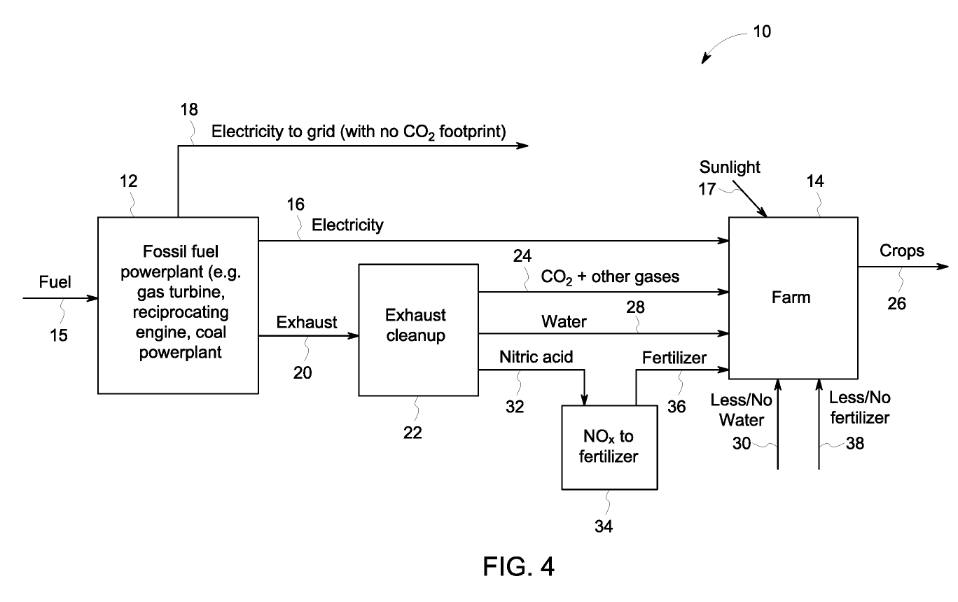

Referring now to FIG. 4, a combination power plant and intensified farm 10 is shown according to another alternate embodiment of the invention. In this embodiment, the combination power plant and intensified farm 10 is identical to the design shown in FIG. 3, with the addition that Nitric acid from the exhaust cleanup facility 22 is provided in line 32 to a NOx to fertilizer conversion facility 34 of a type well-known in the art that converts NOx to fertilizer. The fertilizer generated by the facility 34 is provided to the intensified farm 14 in line 36. As a result, the intensified farm 14 requires a less amount or no fertilizer in line 38 to assist in growing crops 26.

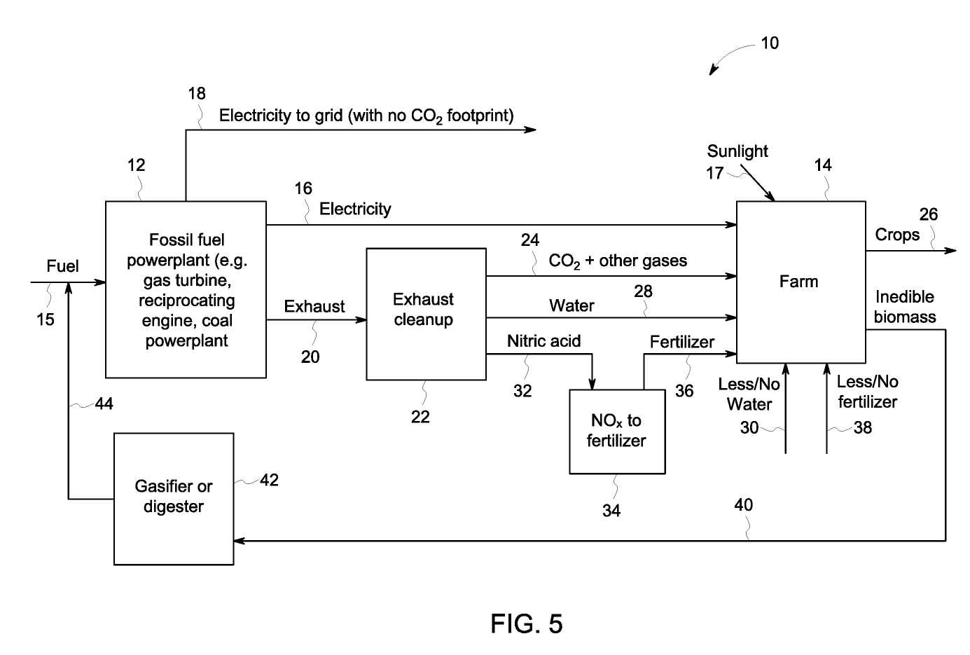

Referring now to FIG. 5, a combination power plant and intensified farm 10 is shown according to another alternate embodiment of the invention. In this embodiment, the combination power plant and intensified farm 10 is identical to the design shown in FIG. 4, with the addition that inedible biomass from the farm 14 is provided in line 40 to a gasifier or digester 42 that converts the inedible biomass to fuel. The fuel generated by the gasifier or digester 42 is provided to the power plant 12 in line 44. As a result, the power plant 12 requires a less amount of fossil fuel in line 15.

For all the embodiments described above, the basic concepts of the combination power plant and intensified farm 10 are as follows:
It is not important to place the intensified farm 14 right in a city, where land costs are exorbitant. Transportation costs are relatively low, so the intensified farm 14 can be in proximity to population centers, but outside city limits where land costs are cheaper—similar to where many power plants are sited.
The indoor farming techniques will reduce water consumption by more than 90%, which makes growing food viable everywhere in the world, even the driest deserts.
A fossil fuel power plant (i.e. a natural gas or other fossil fuel power plant) is used in the embodiments of the invention.
Previous studies have shown that the number one cost of intensified farms is electricity to run the artificial lighting, which is now frequently supplied by light emitting diodes (LEDs). The combination power plant and intensified farm 10 of the invention enables that the value of the crops 26 produced by the intensified farm 14 to be greater than the cost of the electricity 16 to grow the crops 26.
Growing merely lettuce or tomatoes doesn't feed the world. The combination power plant and intensified farm 10 of the invention allows for the viability of a wider range of crops.
General Electric (GE) Jenbacher engines run on fossil fuels, such as natural gas, landfill gas, sewage gas, biogas, mine gas, coal gas and syngas. There are existing installations where they affordably clean up their exhaust to provide CO₂ to tomato greenhouses. It is assumed that cleaning up the exhaust of a GE 9HA gas turbine or coal power plant is similarly viable.
Most existing indoor or vertical farms buy their electricity, so they are paying retail prices. And in the case of GE Jenbacher cogeneration of combined heat and power (CHP) applications, the cost of electricity is moderate. Pairing an intensified or vertical farm with a GE 9HA gas turbine, especially in countries with ready access to affordable natural gas, provides a significant economic advantage in cheaper real electricity costs.
In the combination power plant and intensified farm 10 of the invention, the “farmers” are envisioned to be industrial operators, similar to a power plant operator or a factory operator. This is important, as there is added value to be unlocked in using the farm to help balance load, because the farm plants can tolerate periods where the lights are turned down temporarily to meet demand on the grid.
There are potential other synergies. As described below, the value of coupling electricity and CO₂ from the power plant 12 to the intensified farm 14 is determined. However, there are two other potentially valuable linkages. The NOx in line 32 produced by the power plant 12 might be a viable replacement for the fixed Nitrogen required for fertilizer. If this is the case, gas turbines can be used to intentionally maximize NOx, not minimize NOx. Additionally, capturing the NOx from the exhaust stream 20 means that H₂O can be condensed and provided in line 28, thereby further offsetting the minimal water consumption of the intensified farm 14.

In one example of the combined power plant and intensified farm 10 of the invention, the power plant 12 comprises a GE 9HA gas turbine. In this example:
An 80-acre indoor farm 14 sited very near to a 9HA power plant 12.
Sited within 100 miles of a population center.
The farm 14 consumes 100% of the CO2, but uses only about 55-60% of the electricity.
The remaining electricity is sold to the grid as carbon-free electricity, and the plant operator is allowed to enjoy whatever financial incentives are afforded to other carbon-free power sources.
The farm 14 produces a wide range of crops 26, and has a harvest of each of these crops every day of the year.
The farm 14 uses 90% less water than traditional farming.
The farm 14 uses no pesticides, and substantially less fertilizer.
The farm 14 uses 100% artificial lighting from LEDs.

When a power plant and a farm are linked in close proximity, there are several hybridizations that can be afforded. Two concepts considered here that would reduce the carbon footprint of the crops is converting NOx to fertilizer, and converting biomass waste to methane.

One aspect of the invention is that the power plant 12 produces all of the Nitrogen-fixing fertilizer for the farm 14, as shown in FIG. 3. Gas turbines make NOx, which is a fixed form of Nitrogen. However, the NOx can be condensed out of the exhaust stream with water, forming nitric acid, which could then be feed into a unit for processing into fertilizer. This would be a locally-produced, carbon-free source of fertilizer, significantly reducing the carbon footprint of the food, especially relative to conventional farming.

A key feature of the combination power plant and intensified farm 10 is the vastly reduced greenhouse gas (GHG) footprint associated with the food produced. In order to maintain the low GHG profile of the amount of external materials (such as fertilizers that are required for growth) need to be minimized. The NOx produced as part of the combustion process performs essentially the first step to fix atmospheric N₂ into a usable form for crop growth. The remaining steps encompass the electrolytic technology.

In one embodiment, the technology would consist of the following steps: 1) NOx scrubbing from the flue gas to form an aqueous solution containing NO/NO₂ compounds; 2) NOx oxidation would occurs through direct or indirect electron transfer from the anode in an electrochemical cell. The NOx in the scrubbing fluid would be directed through the cell; 3) NOx conversion to nitrogen is done using electrolytic oxidation, where the power to operate the electrochemical cell is provided by the excess power from the power plant 12 that is not being used for farm operations; 4) the NO₃ formed from the electrolytic oxidation of the NOx species may be either precipitated as a salt (e.g., Ca(NO₂)2), or concentrated through a membrane process and fed directly into the crop production operations. Assuming that this process can be performed efficiently, the entire Nitrogen requirement for the farm 14 may be satisfied by the NOx produced in the power plant 12 and operated by the excess energy.

It will be appreciated that the invention is not limited by the technology used to convert NOx to fertilizer, and that the invention can be used with any desirable process to convert NOx from the power plant 12 to fertilizer used by the farm 14.

This feature of the farm operation would substantially lower the GHG footprint of the food product as well as eliminate air pollutants that would likely require abatement by some a different technology. Air quality control systems would be parasitic (i.e., requires energy without producing a product valuable to the operation of the farm) to the overall system compared to this invention.

There is an additional possible carbon benefit. The vertical farm will produce a certain amount of biomass, depending on the crop that is grown. This biomass can be processed through a digester and turned into methane that can be burned in the gas turbine. Biomass energy conversion is well understood, but rarely economical. One contributor to the poor economics of biomass is the fact that the biomass is spread over a very large amount of land in conventional farms, and needs to be collected and transported to the digester. Additionally, because most crops are seasonal, there isn't a steady stream of biomass feedstock, and then the digester fuel needs to be delivered to the power plant.

However, the combination power plant and intensified farm 10 shown in FIG. 4 changes all of that. The biomass is produced over a land footprint that is more than 100 times more compact, all but eliminating the need to transport the biomass over long distances. Additionally, since there are no seasons, crops can be managed to create biomass feedstocks on a more continuous basis. Finally, the digester can be located right at the power plant. Essentially, this allows the plant to recycle some of the biomass back into fuel. The team has not computed the amount of biomass-to-methane conversion that is possible, nor the economics of doing so. However, if biomass is ever going to be affordable, this may very well be the most affordable method.

There are other secondary benefits to the combination power plant and intensified farm 10 of the invention. Some include:
Food security. To be truthful, international trade is very efficient, and the cost to ship crops around the world is actually quite low, and we know that all countries value some level of food security. What's not clear is what cost are countries willing to bear to increase their food security.
Short cycle from harvest to table. Basically, this form of farming allows a lot more folks to enjoy perfectly fresh produce every day of the year. There is no need for long-term storage, or long shipping times. Every person every day can eat vegetables or fruit that was picked that day. There is likely a premium in the market for the price of such freshness, especially for crops like tomatoes, corn, and some fruits, where quality is usually sacrificed in exchange for longevity. The duration of this cycle depends on the distribution networks that are formed around the farm.
Price for carbon-free electricity. Since the combination GE 9HA gas turbine and intensified farm 10 does produce net electricity with no carbon footprint, it is possible in the future for regulations to give this electricity a price advantage over carbon-emitting forms of electricity.
Impact of existing subsidies on food crops. Corn is a particularly poignant example. If crops were all priced on a true-cost basis, then more crops might be economical than shown here. Conversely, we could apply existing subsidies to each crop in the analysis to more accurately reflect the net cost of the crop.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A combination power plant and intensified farm, comprising:
a power plant for generating electricity and an exhaust stream;
an exhaust cleanup facility for capturing CO₂ from the exhaust stream; and
an intensified farm operatively coupled to the fossil fuel power plant and the exhaust cleanup facility;
wherein at least a portion of CO₂ from the exhaust cleanup facility is provided to the intensified farm to assist in raising of at least one crop.

2. The combination power plant and intensified farm of claim 1, wherein at least a portion of electricity from the power plant is provided to the intensified farm to assist in raising of the at least one crop.

3. The combination power plant and intensified farm of claim 1, wherein the exhaust cleanup facility further provides H₂O to the intensified farm to assist in raising of the at least one crop.

4. The combination power plant and intensified farm of claim 1, further comprising a NOx to fertilizer conversion facility operatively coupled to the exhaust cleanup facility and the intensified farm that converts NOx from the exhaust cleanup facility to a fertilizer and provides the fertilizer to the intensified farm to assist in raising of the at least one crop.

5. The combination power plant and intensified farm of claim 1, further comprising a gasifier or digester that receives an inedible biomass from the intensified farm, and wherein the gasifier or digester converts the inedible biomass to a fuel and provides the fuel to the power plant.

6. The combination power plant and intensified farm of claim 1, wherein the power plant comprises a fossil fuel power plant.

7. The combination power plant and intensified farm of claim 1, wherein the power plant comprises a gas turbine.

8. A combination power plant and intensified farm, comprising:
a power plant for generating electricity and an exhaust stream;
an exhaust cleanup facility for capturing CO₂ and H₂O from the exhaust stream; and
an intensified farm operatively coupled to the fossil fuel power plant and the exhaust cleanup facility;
wherein at least a portion of electricity from the power plant and at least a portion of CO₂ from the exhaust cleanup facility is provided to the intensified farm to assist in raising of at least one crop.

9. The combination power plant and intensified farm of claim 8, wherein the exhaust cleanup facility further provides H₂O to the intensified farm to assist in raising of the at least one crop.

10. The combination power plant and intensified farm of claim 8, further comprising a NOx to fertilizer conversion facility operatively coupled to the exhaust cleanup facility and the intensified farm that converts NOx from the exhaust cleanup facility to a fertilizer and provides the fertilizer to the intensified farm to assist in raising of the at least one crop.

11. The combination power plant and intensified farm of claim 8, further comprising a gasifier or digester that receives an inedible biomass from the intensified farm, and wherein the gasifier or digester converts the inedible biomass to a fuel and provides the fuel to the power plant.

12. The combination power plant and intensified farm of claim 8, wherein the power plant comprises a fossil fuel power plant.

13. The combination power plant and intensified farm of claim 8, wherein the power plant comprises a gas turbine.

14. A combination power plant and intensified farm, comprising:
a power plant for generating electricity and an exhaust stream;
an exhaust cleanup facility for capturing CO₂ and H₂O from the exhaust stream; and
a NOx to fertilizer conversion facility operatively coupled to the exhaust cleanup facility and the intensified farm that converts NOx from the exhaust cleanup facility to a fertilizer; and
an intensified farm operatively coupled to the fossil fuel power plant and the exhaust cleanup facility;
wherein at least a portion of electricity from the power plant and at least a portion of CO₂ and H₂O from the exhaust cleanup facility is provided to the intensified farm to assist in raising of at least one crop, and
wherein at least a portion of the fertilizer from the NOx to fertilizer conversion facility is provided to the intensified farm.

15. The combination power plant and intensified farm of claim 14, further comprising a gasifier or digester that receives an inedible biomass from the intensified farm, and wherein the gasifier or digester converts the inedible biomass to a fuel and provides the fuel to the power plant.

16. The combination power plant and intensified farm of claim 14, wherein the power plant comprises a fossil fuel power plant.

17. The combination power plant and intensified farm of claim 14, wherein the power plant comprises a gas turbine.
